(19) United States
(12) Patent Application Publication
(10) Pub. No.: US 2015/0132448 A1
(43) Pub. Date: May 14, 2015

(54) LOW-CALORIE SOL FOOD MATERIAL, LOW-CALORIE SOL FOOD MATERIAL IN PACKAGE CONTAINER, AND MANUFACTURING METHOD THEREOF

(71) Applicant: HARADA FOODS CO.,LTD., Yamaguchi (JP)

(72) Inventor: Toshihiro Harada, Yamaguchi (JP)

(21) Appl. No.: 14/602,957

(22) Filed: Jan. 22, 2015

Related U.S. Application Data
(63) Continuation of application No. PCT/JP2012/075991, filed on Oct. 5, 2012.

(51) Int. Cl. A23L 1/0528

(52) U.S. Cl. CPC A23L 1/0528; A23V 2002/00
USPC 426/131; 426/573

(57) ABSTRACT

A manufacturing method of a low-calorie sol food material includes four steps. The first step includes stirring a mixture of water, glucomannan or konjac refined flour or a combination thereof, and a poorly-soluble water absorbent, whereby the mixture is swollen to form a sol substance. The second step includes kneading an alkaline agent into the sol substance to prepare a pH-adjusted sol substance. The third step includes heating the pH-adjusted sol substance under a temperature condition at 70 to 130° C. to make the pH-adjusted sol substance into a gelatinous substance. The fourth step includes cooling the gelatinous substance to a temperature range of 0 to 15° C. to make the gelatinous substance solate.

### CROSS-REFERENCE TO RELATED APPLICATIONS

The present application is a Continuation and claims benefit, pursuant to 35 U.S.C. §120, of International Patent Application No. PCT/JP2012/075991 filed on Oct. 5, 2012, which is incorporated by reference in its entirety herein.

### BACKGROUND OF THE INVENTION

1. Field of the Invention

The present invention relates to a low-calorie sol food material and a low-calorie sol food material in a package container which are excellent in quality stability and can be stored and distributed, and a manufacturing method thereof.

2. Background Art

Conventionally, konjac foods containing glucomannan as an active ingredient are largely indigestible in a human digestive tract and partly converted into fatty acid by intestinal microorganisms for use. Thereby, konjac is known as an extremely low calorie food (5 to 7 kcal per 100 g) and has attracted attention as a bulking food material for decreasing calories of a processed food with excessive calories.

As an example of such konjac foods, a pasty konjac (thermoreversible sol substance) which can be used by kneading it into meat processed foods and cereal processed foods, is gelatinous in a heated state and sol in a cool-temperature state, is known.

Such a thermoreversible sol substance has advantages that calories can be considerably decreased without greatly deteriorating taste and texture of foods by replacing a part of a ground meat product and a cereal processed food. Thus, it is expected to exert an excellent effect as a diet food.

However, for such a thermoreversible sol substance, it was difficult to mass produce a product with homogenous quality with high efficiency. In addition, there was a problem that it could not be stored due to extremely poor quality stability after manufacture. Therefore, thermoreversible sol substances were hardly common as food materials for processed foods.

Although no prior art having the same problem to be solved as that of the invention of this patent application has been found at this time, the products as mentioned below are known as prior arts in the relevant technical field.

Patent Document 1 (Japanese Published Unexamined Patent Application No. 2009-5615) discloses an invention related to a processed food named “processed food using a konjac paste” using a konjac paste which is a novel material for food processing.

The konjac paste disclosed in Patent Document 1 is a paste material prepared by a procedure that a konjac powder is added to a sufficient amount of water to swell it, then a coagulant comprising e.g. sodium citrate and calcium lactate is added and further stirred, which is once gelled by heating to a temperature range of 80 to 150° C., and made to solate through rapid cooling e.g. using ice water. In addition, the invention relates to a ground meat product or grain powder product comprising 20 to 80 wt % of the above-mentioned konjac paste. Furthermore, it relates to a frozen distribution article prepared from this ground meat product or grain powder product.

A ground meat product which has excellent texture and also has a juicy feeling can be provided by using the konjac paste disclosed in Patent Document 1 as mentioned above. In addition, since taste, texture and juicy feeling are not deteriorated even by blending 50 wt % or more of konjac paste, a method for manufacturing a food material which makes significant contributions as a health food or a diet food can be provided. Since the ground meat product as disclosed in Patent Document 1 is a low-calorie food, it is also effective for solving problems of various adult diseases and child obesity, and thus useful food materials can be provided. In addition, these ground meat products can be diverted to pet foods by changing quality and a compounding ratio of the meat material, and they can also be expected to be effective in the diet of pets.

Low-calorie breads, cakes and noodles having excellent texture which have not been obtained from conventional konjac pastes can also be provided by mixing the konjac paste disclosed in Patent Document 1 with a grain powder. In addition, since it is possible to use rice flour instead of flour, concerns regarding the onset of allergies resulting from flour can also be avoided, and konjac paste can contribute to efficient use of crushed rice which occurs year after year.

Patent Document 2 (Japanese Published Unexamined Patent Application No. S63-68054) discloses an invention related to a thermoreversible konjac titled “reversible konjacs and food additives comprising them,” which reversibly switches between a liquid state and a coagulated state according to the degree of cold and warm temperature.

Characteristically, the reversible konjac disclosed in Patent Document 2 is obtained by adding caustic soda, caustic potash, sodium carbonate, potassium carbonate, calcium carbonate, sodium sulfite, magnesium carbonate, sodium hydrogen carbonate, hydrogen ammonium carbonate or ammonium carbonate alone, or a mixture thereof to konjac root or an aqueous konjac powder and mixing them so as to be at pH 10 or lower, and heating them to 70 to 130° C., and reversibly switches between a liquid state and a coagulated state according to the temperature.

The reversible konjac disclosed in Patent Document 2 can switch from a liquid state to a paste state at a cold temperature, and from a pudding-like state to a solid coagulation state at a warm temperature.

In addition, the textures at the cold and warm temperatures can be approximately the same by adding starch to the reversible konjac disclosed in Patent Document 2.

Various novel foods can be produced by adding such a reversible konjac as disclosed in Patent Document 2 to foods.

The konjac paste and the reversible konjac as disclosed in Patent Documents 1 and 2 mentioned above (herein, collectively called thermoreversible sol substances) are materials prepared by temporarily producing a material in a transition state before it is thoroughly coagulated when manufacturing a conventionally-known gelatinous konjac. The methods for generating such a transition state may include e.g. methods of adjusting an amount of the added coagulant, heating temperature and heating time, and as required, performing cooling treatment after heating treatment. Herein, the word “temporarily” means that this state is not a fixed property.

That is, the thermoreversible sol substances as disclosed in Patent Documents 1 and 2 mentioned above repeat switching between cool-warm states like sol-gel states before coagulation of the glucomannan is thoroughly progressed. However, if the coagulation of the glucomannan progresses for some reason, such a switch in state is not caused, and it thoroughly gelates (irreversible gelation).

Thus, an improvement in quality stability of the thermoreversible sol substance means that the time to irreversible gelation is prolonged by slowly progressing coagulation of glucomannan in a thermoreversible sol substance in a transition state as mentioned above. Additionally, in such a thermoreversible sol substance in a transition state, conditions which significantly affect a coagulation rate of glucomannan are an alkalinity value and a temperature of the solution.

As mentioned above, since thermal reversibility of the thermoreversible sol substances as disclosed in Patent Documents 1 and 2 was extremely unstable, it was difficult to maintain their properties for a long period of time. That is, the thermoreversible sol substances as disclosed in Patent Documents 1 and 2 were not suitable for storage and transport.

Paragraph 0030 in the specification in Patent Document 1 discloses a technical content that a konjac paste with an alkaline agent is packed in a retort pouch and heated, and then cooled to render it pasty.

As the most common form for distributing the above-mentioned konjac paste, there could possibly be a method of packing in a retort pouch.

In this case, since the konjac paste packed in the retort pouch was relatively thinner on the margin and corner portions of the retort pouch, the margin and corner portions of the retort pouch were excessively heated in heating treatment, and as a result, coagulation of glucomannan rapidly progressed locally at these sites, and irreversible gelation partly occurred. Thus, in the method disclosed in Citation 1, it was difficult to produce a konjac paste having homogenous quality in a retort pouch.

In addition, even in a case that a thickness was uniformed by devising a shape of a retort pouch, the thickness of the konjac paste was still relatively thinner on corner portions of the pouch, and it was difficult to produce a konjac paste having homogenous quality.

That is, it was difficult to efficiently produce a konjac paste as disclosed in Citation 1.

Furthermore, when the konjac paste disclosed in Patent Document 1 was frozen, it irreversibly gelated, and therefore the konjac paste itself could not be cryopreserved while maintaining the state having thermal reversibility. Therefore, it is considered that, in the invention disclosed in Patent Document 1, the konjac paste was required to be processed into a frozen distribution article after it was processed into a ground meat product or a grain powder product.

In addition, in the invention disclosed in Citation 1, since the konjac paste is distributed in a form of a frozen distribution article, no necessity to store and distribute the konjac paste itself is described. Consequently, the invention disclosed in Patent Document 1 does not disclose any technical content that the quality is stabilized for distribution and storage of the konjac paste.

Also in the case of the invention disclosed in Patent Document 2, it is not conceived that the reversible konjac itself is distributed, like in the case of the invention disclosed in Patent Document 1.

Thus, there is no disclosure nor suggestion or statement about the necessity to stabilize the quality in distribution and storage of the reversible konjac (thermoreversible sol substance), nor was the technical content disclosed.

### SUMMARY OF THE INVENTION

The present invention was made for addressing such conventional circumstances, and the object of the invention is to provide a low-calorie sol food material and a low-calorie sol food material in a package container which are thermoreversible sol substances capable of sustaining thermal reversibility in a refrigerated state for a long period of time, improving productivity, and homogenizing the quality in manufacture with packaging, and a manufacturing method thereof.

In order to achieve the above-mentioned object, the manufacturing method of the low-calorie sol food material which is the invention described in claim 1 characteristically comprises: a first step that water, glucomannan or konjac refined flour or a combination thereof, and a poorly-soluble water absorbent are stirred, and then swollen to prepare a sol substance; a second step that an alkaline agent is kneaded into the sol substance to prepare a pH-adjusted sol substance; a third step that the pH-adjusted sol substance is heated under a temperature condition at 70 to 130° C. to make it into a gelatinous substance; and a fourth step that the gelatinous substance is cooled to a temperature range of 0 to 15° C. to make the gelatinous substance solate.

In the invention described in claim 1 constituted as mentioned above, the first step has an effect to produce the sol substance comprising water, the glucomannan or the konjac refined flour or the combination thereof and the poorly-soluble water absorbent. In not only claim 1 but also this patent application, there is a definition as “glucomannan or a konjac or a combination thereof,” and this definition is for reducing a situation that a case using a material called konjac refined flour which includes glucomannan as an active ingredient and also includes some impurities is eliminated. Accordingly, when the glucomannan is conceptually defined as not only glucomannan without impurities but also konjac refined flour with impurities, only glucomannan may be defined as the material. Alternatively, as described also in Embodiments, “glucomannan or konjac or a combination thereof” may be comprehensively defined as “glucomannan-containing material powder.” In addition to claim 1, the same applies to other claims as well as the description in Embodiments.

The second step has an effect to adjust the sol substance to be alkaline. Additionally, in the second step, the alkaline agent (the alkaline agent is added as an alkaline aqueous solution or a dispersion liquid of the alkaline agent) is preferentially absorbed in the poorly-soluble water absorbent dispersed in the sol substance.

Furthermore, the third step has an effect to progress coagulation of the glucomannan by heating the glucomannan under an alkaline environment. At this time, a coagulation rate of the glucomannan is decreased by the alkaline agent gradually supplied from the poorly-soluble water absorbent dispersed in the pH-adjusted sol substance. That is, the poorly-soluble water absorbent has an effect to slowly progress coagulation of the glucomannan before and after manufacture of the low-calorie sol food material.

In the third step, syneresis occurs at a level which cannot be visibly confirmed with progress of coagulation of the glucomannan, but this water is absorbed into the poorly-soluble water absorbent so that water retentivity of the gelatinous substance is maintained. That is, a state that syneresis does not apparently occur is prolonged in the gelatinous substance produced in the third step.

The fourth step has an effect to extremely decrease the coagulation rate of the glucomannan by cooling the gelatinous substance produced in the third step to a temperature range of 0 to 15° C. Thereby, this step has an effect to produce the thermoreversible sol substance in a transition state before the glucomannan is thoroughly coagulated.

In the invention described in claim 1, unless the gelatinous substance is once produced by heating in the third step, the substance cannot be rendered the thermoreversible sol substance which switches between sol-gel states in cool-warm states. Meanwhile, when coagulation of the glucomannan progresses to an extent where syneresis from the gelatinous substance produced in the third step can be visibly confirmed, the substance cannot be subsequently rendered the thermoreversible sol substance even by cooling in the fourth step.

In addition, when the poorly-soluble water absorbent was not kneaded into the pH-adjusted sol substance, visibly-confirmable syneresis occurred within a little time from production of the gelatinous substance by heating, and the gelatinous substance irreversibly gelated, thus a thermoreversible sol substance with constant quality could not be efficiently produced.

On the contrary, in the invention described in claim 1, the poorly-soluble water absorbent is dispersed in the pH-adjusted sol substance, so that water retentivity of the gelatinous substance produced in the third step is enhanced, and the timing for occurrence of visibly-confirmable syneresis from the gelatinous substance is delayed. Thereby, the invention of claim 1 has an effect to increase the time length for determining the timing for starting the cooling treatment in the fourth step by discontinuing the heating of the gelatinous substance under heating. That is, the poorly-soluble water absorbent dispersed in the pH-adjusted sol substance acts as a buffer for increasing the range of the timing for starting the fourth step.

In the invention described in claim 2, the manufacturing method of the low-calorie sol food material is the manufacturing method of the low-calorie sol food material described in claim 1, and characteristically has, between the second and third steps, a containing and packing step that the pH-adjusted sol is sealed in a package container with heat resistance and water tightness.

The invention described in claim 1 as constituted above has the same effect as that of the invention described in claim 2, as well as an effect to simultaneously complete a heating treatment for progressing coagulation of the glucomannan and a heating treatment for sterilizing the contents in the package container by providing the containing and packing step between the second and third steps.

In addition, it has an effect to prevent a case that when sites such as outer margin portions and their peripheries or corner portions and their peripheries of the package container on which the thickness of the pH-adjusted sol substance is relatively thin due to dispersion of the poorly-soluble water absorbent in the pH-adjusted sol substance are excessively heated in the third step, coagulation of the glucomannan rapidly progresses at the sites and irreversibly gelates.

Characteristically, in the invention described in claim 3, the low-calorie sol food material is a low-calorie sol food material in a range of pH 7 to 8 which is constituted by heating a pH-adjusted sol substance obtained by kneading an alkaline agent into a sol substance prepared by stirring and swelling water, glucomannan or konjac refined flour or a combination thereof, and a poorly-soluble water absorbent to gelate, then cooling to solate, a percentage of moisture content in the sol substance is 90 wt % or more, a contents percentage of glucomannan or the konjac refined flour or the combination thereof in the sol substance is 1.4 wt % or more, an amount of the added poorly-soluble water absorbent is 10 wt % or more of the total weight of the glucomannan or the konjac refined flour or the combination thereof.

In the invention described in claim 3 as constituted above, the glucomannan contained in glucomannan or konjac refined flour or a combination thereof has an effect that the glucomannan is progressively coagulated by heating under an alkaline environment and gelates. Also, the glucomannan has an effect that the coagulation rate of the glucomannan is rapidly decreased by rapidly cooling this gelled glucomannan to produce a sol coagulated body in a transition state before the glucomannan is thoroughly coagulated. Furthermore, the coagulated body in the transition state is a thermoreversible sol substance which switches between gel-sol states in warm-cool states, and has a property suitable for a food material for a ground product or the like.

This thermal reversibility is not a property fixed in the thermoreversible sol substance, but merely a temporal property which occurs during the coagulation process of the glucomannan. Consequently, when heat continuously acts on this thermoreversible sol substance under the alkaline environment, the coagulation of the glucomannan is progressed and syneresis occurs, resulting in loss of thermal reversibility through irreversible gelation.

The poorly-soluble water absorbent dispersed and mixed in such a thermoreversible sol substance has an effect to delay the irreversible gelation of the glucomannan as mentioned in the description of the invention described in claim 1.

In addition, pH of the low-calorie sol food material described in claim 3 is approximately neutral ranging pH 7 to 8. Thus, the low-calorie sol food material described in claim 3 has an effect that when the low-calorie sol food material described in claim 3 is kneaded into other food materials, denature of taste and color of other food materials are suppressed.

In the invention described in claim 4, the low-calorie sol food material is the low-calorie sol food material described in claim 3, and is characteristically a natural polymer containing 80 wt % or more of a substance insoluble to water.

The invention described in claim 4 as constituted above describes the properties of the poorly-soluble water absorbent constituting the invention described in claim 3 in more detail, and its effect is the same as that of the invention described in claim 3.

In the invention described in claim 5, the low-calorie sol food material is the low-calorie sol food material described in claim 4 and is characterized in that the poorly-soluble water absorbent is a dietary fiber derived from plant resources.

The invention described in claim 5 as constituted above not only has the same effect as that of the invention described in claim 4 but also an effect to bring the invention described in claim 5 almost tasteless and odorless by using a dietary fiber derived from plant resources for the poorly-soluble water absorbent. Also, an effect that all solid matters other than the alkaline agent in the invention described in claim 5 are used for a considerably low-calorie food material is included.

In the invention described in claim 6, the low-calorie sol food material is the low-calorie sol food material described in claim 5, and characterized in that a mean fiber length of dietary fibers is within a range of 30 to 80 μm.

The invention as constituted above not only has the same effect as that of the invention described in claim 5 but also an effect that the mean fiber length of dietary fibers dispersed in the low-calorie sol food material is within the range of 30 to 80 μm to reduce occurrence of stickiness on the low-calorie sol food material due to addition of dietary fibers. Thereby, an effect that mold releasability of a molded article into which the invention described in claim 5 is kneaded is improved when the invention is kneaded as a part of the ground meat product, is included.

In the invention described in claim 7, the low-calorie sol food material in a package container is characterized in that the low-calorie sol food material described in any one of claims 3 to 6 is sealed in the package container with heat resistance and water tightness.

The invention described in claim 7 as constituted above not only has the same effect as that of the invention described in each of claims 3 to 6 but also an effect that the package container contains therein the low-calorie sol food material which is a thermoreversible sol substance and seals it.

Thereby, an effect that a heat treatment of the low-calorie sol food material packed in the package container can be easily and hygienically performed is included.

Furthermore, an effect that the invention described in claim 7 comprises the package container, thereby the low-calorie sol food material contained therein can be easily refrigerated and stored, or distributed, is included.

### ADVANTAGEOUS EFFECT OF THE INVENTION

According to the invention described in claim 1, a low-calorie sol food material in a homogenous state without a partially irreversibly-gelled region, which slowly progresses irreversible gelation in a refrigerated state, can be manufactured and provided. Thereby, a low-calorie sol food material which has high stability of the quality in a refrigerated state can be provided.

As a result, it becomes possible to store and distribute the low-calorie sol food material itself which was manufactured by the invention described in claim 1. Thereby, the low-calorie sol food material manufactured by the invention described in claim 1 can be easily used as a part of a processed food.

According to the invention described in claim 2, a heating treatment for progressing coagulation of the glucomannan and a heating treatment for sterilizing the contents in the package container can be simultaneously completed by providing the containing and packing step between the second and third steps.

Thereby, a hygienic low-calorie sol food material in a form suitable for storage and distribution can be efficiently produced.

That is, productivity of the low-calorie sol food material which is safe, maintains stable quality in refrigeration storage, and is easy to distribute as a food can be improved.

In addition, according to the invention described in claim 2, occurrence of local irreversible gelation at sites where the contents are relatively thin such as outer margin portions and their peripheries or corner portions and their peripheries in the package container, can be prevented. As a result, inhomogeneity of the quality of the low-calorie sol food material in a package container can be prevented.

In addition, after completion of the manufacture of the low-calorie sol food material manufactured according to the invention described in claim 2, the low-calorie sol food material need not be heated again for the purpose of e.g. sterilization. Thus, an absolute calorie level which affects the low-calorie sol food material packed in the package container can be reduced.

As a result, progression of coagulation and irreversible gelation of the glucomannan in the low-calorie sol food material can be considerably delayed. Consequently, a quality keeping period of the low-calorie sol food material manufactured according to the invention described in claim 2 can be prolonged.

The invention described in claim 3 is an invention in which the low-calorie sol food material manufactured according to the invention described in claim 1 is represented as an invention of an article, and has the same effects as that of the invention described in claim 1.

In addition, the low-calorie sol food material described in claim 3 mainly comprises water and is a food material with extremely few calories. Consequently, by combining the low-calorie sol food material described in claim 3 and other food materials, a processed food with fewer calories than that in the case that the processed food is composed of only other food materials can be provided. In addition, such a low-calorie processed food can contribute to treatment and prevention of lifestyle diseases resulting from dietary habits.

Furthermore, an intake of dietary fibers can be increased by taking the processed food using the low-calorie sol food material described in claim 3. As a result, effects to improve health associated with an increase in the intake of dietary fibers can also be expected.

In addition, the pH in the invention described in claim 3 is approximately neutral ranging pH 7 to 8. Thus, when a processed food is manufactured by kneading such an invention described in claim 3 into other food materials, tastes and colors of other food materials are extremely unlikely to be deteriorated.

Consequently, a food material which has both excellent thermocoagulation property and deterioration preventive property as a bulking filler for processed foods can be provided.

The invention described in claim 4 as constituted above describes the properties of the poorly-soluble water absorbent constituting the invention described in claim 3 in more detail, and its effect is the same as that of the invention described in claim 3.

The invention described in claim 5 not only has the same effect as that of the invention described in claim 4 but can also bring about an almost tasteless and odorless invention described in claim 5 by using a dietary fiber derived from plant resources for the poorly-soluble water absorbent.

As a result, taste and flavor of the other food materials can be prevented from being deteriorated when the processed food is made by adding the invention described in claim 5 to the other food materials. Therefore, the versatile low-calorie sol food material can be provided by the invention described in claim 5.

Additionally, in the invention described in claim 5, all solid contents other than the alkaline agent consist of dietary fibers. As a result, the calories of the low-calorie sol food material described in claim 5 can be substantially reduced. Thus, the calories of the processed food into which the low-calorie sol food material is kneaded in the invention described in claim 5 can be further reduced. Consequently, therapeutic effects and preventive effects on lifestyle diseases resulting from dietary habits can be further improved by intaking foods using the invention described in claim 5.

Furthermore, an intake of dietary fibers can be further increased by taking the processed food into which the invention described in claim 5 is kneaded. Thereby, health promoting effects resulting from intake of dietary fibers are also likely to be exerted.

The invention described in claim 6 not only has the same effect as that of the invention described in claim 5 but can also make the low-calorie sol food material to be in a less sticky state by setting a mean fiber length of dietary fibers dispersed in the low-calorie sol food material to within 30 to 80 μm.

In this case, the mold releasability can be improved particularly when the processed food is manufactured by kneading and molding the invention described in claim 6 as a part of a ground meat product.

As a result, productivity of the processed food made by kneading in the invention described in claim 6 can be improved, and appearance of the product can be improved.

The invention described in claim 7 is an invention in which the low-calorie sol food material manufactured according to the invention described in foregoing claim 2 and sealed in an package container is represented as an invention of an article.

According to the invention described in claim 7, particularly when a pH-adjusted sol substance is heated so as to gelate after being sealed in a package container, sites where the contents are relatively thinner such as outer margin portions and their peripheries or corner portions and their peripheries in the package container are excessively heated locally and irreversibly gelate, inhomogeneity of the quality of the low-calorie sol food material can be prevented in the package container.

Furthermore, according to the invention described in claim 6, the heating treatment for progressing coagulation of glucomannan and the heating treatment for sterilizing the contents in the package container can be simultaneously carried out, and thus productivity of the low-calorie sol food material described in each of claims 3 to 5 can be enhanced.

In addition, in the case of the invention described in claim 6, after completion of its manufacture, the low-calorie sol food material need not be heated again e.g. for the purpose of sterilization. Thus, an absolute calorie level which acts on the low-calorie sol food material packed in the package container can be reduced. Thereby, the timing for loss of thermal reversibility due to irreversible gelation of the low-calorie sol food material packed in the package container can be delayed. Consequently, a quality keeping period of the low-calorie sol food material in the invention described in claim 6 can be prolonged.

### BRIEF DESCRIPTION OF THE DRAWINGS

FIG. 1 is a flowchart of the manufacturing method for the low-calorie sol food material according to Example 1 in the present invention.

FIG. 2 is a flowchart of the manufacturing method for the low-calorie sol food material according to Example 2 in the present invention.

FIG. 3 is a structural formula of the glucomannan.

### DESCRIPTION OF REFERENCE SYMBOLS

1a . . . Low-calorie sol food material
1b . . . Low-calorie sol food material in a package container
2 . . . Water
3 . . . Glucomannan-containing material powder (glucomannan or konjac refined flour or a combination thereof)
4 . . . Poorly-soluble water absorbent
5 . . . Alkaline agent
6 . . . Sol substance
7 . . . pH-adjusted sol substance
8 . . . Gelatinous substance
8a . . . Gelatinous substance in a package container
9 . . . pH-adjusted sol substance in a package container
10A, 10B . . . Manufacturing method for the low-calorie sol food material

### DESCRIPTION OF THE PREFERRED EMBODIMENTS

The low-calorie sol food material and the low-calorie sol food material in a package container, and the manufacturing method thereof according to the preferred embodiments of the present invention will be explained in detail with reference to Examples.

### Example 1

The low-calorie sol food material manufactured by the manufacturing method for the low-calorie sol food material according to Example 1 in the present invention is a thermoreversible sol substance which repeats switching between sol-gel states in cool-warm states. In addition, the thermoreversible sol substance according to this Example 1 can sustain its thermal reversibility in a refrigerated state for a long period of time.

The thermal reversibility of the low-calorie sol food material according to Example 1 is not a fixed property, but is merely a temporarily-exerted property. However, since the invention according to Example 1 can maintain this thermal reversibility for a long period of time, it can be stored and distributed in the refrigerated state.

Generally, konjac is produced in a procedure that a sol substance prepared by stirring and swelling the glucomannan or konjac refined flour or a combination thereof together with water is heated under an alkaline environment, and glucomannan molecules are coagulated to irreversibly gelate.

In the conventionally-known manufacturing process for konjac as mentioned above, for example, the environment for coagulating the glucomannan is set to weak alkaline, the heating temperature and the heating time are adjusted, and as required, cooling treatment is carried out after heating treatment, it is possible to produce a sol coagulated body in a transition state before the glucomannan is thoroughly coagulated. And, this coagulated body in the transition state is the thermoreversible sol substance according to the present invention.

Since coagulation of the glucomannan is gradually progressed by thermal action in such a thermoreversible sol substance, the thermal reversibility is lost with time.

Thus, the thermoreversible sol substance was originally an unstable substance, and not suitable for distribution and storage. Therefore, a technology for sustaining this thermal reversibility for as long as possible was required.

For a low-calorie sol food material 1a according to Example 1 of the present invention, the time the glucomannan takes to coagulate in an irreversible gelatinous state is prolonged by dispersing the poorly-soluble water absorbent in the glucomannan molecules. That is, a period until the thermal reversibility is lost is prolonged in the low-calorie sol food material 1a according to Example 1. In addition, the poorly-soluble water absorbent improves water retentivity of the low-calorie sol food material 1a, and delays the timing for visibly-confirmable syneresis from the low-calorie sol food material 1a which is an indicator for judging whether or not the deterioration of quality (irreversible gelation) progresses, to prolong the quality keeping period of the low-calorie sol food material 1a according to the present invention.

Even when this low-calorie sol food material 1a according to Example 1 of the present invention was once slowly frozen and then unfrozen, it had thermal reversibility, and therefore it can be potentially cryopreserved.

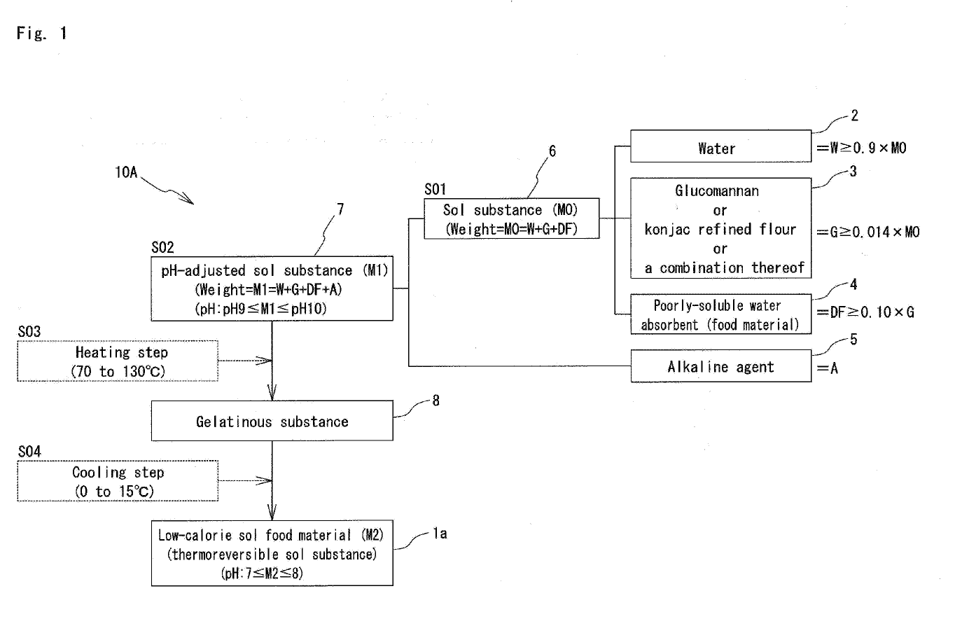

FIG. 1 is a flowchart of the manufacturing method for the low-calorie sol food material according to Example 1 in the present invention.

A manufacturing method 10A for the low-calorie sol food material according to Example 1 is roughly composed of four steps as shown in FIG. 1.

First, a first step is a step that water 2, glucomannan or konjac refined flour or a combination thereof (hereinafter, called a glucomannan-containing material powder 3), and a poorly-soluble water absorbent 4 are respectively weighed in a required amount, then stirred and swollen to prepare a sol substance 6 (Step S01).

Compounding ratio of each material constituting this sol substance 6 is as described below. First, a contents percentage of water 2 is 90 wt % or more to the total weight of the sol substance 6. In addition, a contents percentage of the glucomannan-containing material powder 3 is 1.4 wt % or more to the total weight of the sol substance 6. Furthermore, an additive amount of the poorly-soluble water absorbent 4 is at least 10 wt % or more to the total weight of the glucomannan-containing material powder 3.

Even when the contents percentage of water 2 (percentage of moisture content) in the sol substance 6 is below 90 wt %, there is no problem for manufacture of the low-calorie sol food material 1a and exertion of thermal reversibility. However, since even a trace amount of glucomannan-containing material powder 3 can divert a large amount of water into the sol substance 6, an excessive amount of glucomannan-containing material powder 3 need not be added. On the other hand, when the contents percentage of the glucomannan-containing material powder 3 in the sol substance 6 is below 1.4 wt %, the substance does not coagulate even by heating under an alkaline environment because of the too low concentration of glucomannan, and so the thermoreversible gelatinous substance according to the present invention cannot be produced.

In Example 1, as the glucomannan-containing material powder 3, glucomannan or konjac refined flour may be used alone, alternatively, a combination of these may be used. Because the active ingredient of the konjac refined flour is glucomannan.

In addition, konjac usually contains trimethylamine which is the origin of a so-called fishy smell, and a non-refined one has a strong odor. Thus, when it is intended to bring the low-calorie sol food material 1a according to Example 1 close to odorlessness, konjac refined flour in which odor source substances such as trimethylamine are reduced by refining using alcohols such as ethanol should be used.

Furthermore, the poorly-soluble water absorbent 4 kneaded into the sol substance 6 is a water-absorbable natural polymer containing 80 wt % or more of a substance insoluble to water. This poorly-soluble water absorbent 4 is more preferably a water-absorbable natural polymer containing 90 wt % or more of a substance insoluble to water, i.e. a water absorbent with lower water absorbency than that of the glucomannan.

Additionally, actions and effects of the poorly-soluble water absorbent 4 will be explained below in detail.

Next, the second step in the manufacturing method 10A for the low-calorie sol food material according to Example 1 is a step that an alkaline agent 5 is kneaded into the sol substance 6 prepared in the above step S01 to prepare a pH-adjusted sol substance 7 in a range of pH 9 to 10 (step S02). That is, a step that a swelled body of the glucomannan is rendered weak alkaline (in a range of pH 9 to 10).

In the step S02, for the alkaline agent 5 kneaded into the sol substance 6, any alkaline agents which are used in the conventionally-known manufacturing method for konjac can be used. However, an appropriate agent should be selected according to its application so that the tastes and colors of other food materials are not deteriorated, because the low-calorie sol food material 1a manufactured by the manufacturing method 10A for the low-calorie sol food material according to Example 1 is kneaded into other food materials for use.

For reference, the alkaline agent 5 usable in the manufacturing method 10A for the low-calorie sol food material according to Example 1 may include hydroxylated compounds such as calcium hydroxide, sodium hydroxide, potassium hydroxide and magnesium hydroxide, carbonates such as sodium carbonate, potassium carbonate, calcium carbonate and magnesium carbonate, sulfates such as calcium sulfate, potassium sulfate, sodium sulfate and magnesium sulfate, organic acid salts such as sodium citrate, sodium tartrate, sodium malate, sodium acetate, sodium lactate and sodium succinate, as well as phosphates such as sodium polyphosphate, sodium pyrophosphate and sodium metaphosphate. In addition to these basic salts, usable basic amino acids include arginine, lysin, histidine, ornithine, citrulline and the like. Note that these alkaline agents may be used alone, alternatively, at least two or more selected from them may be combined for use.

Note that the alkaline agent 5 is added in a form of an alkaline aqueous solution by being dissolved in water, but if the alkaline agent 5 cannot be dissolved in water, the alkaline agent 5 may be added in a form of a dispersion liquid prepared by dispersing it in water.

In addition, in order to preferably sustain thermal reversibility of the low-calorie sol food material 1a according to the present invention, it is preferable to use an alkaline agent having as large molecular weight as possible. The reason for this is that when the molecular weight of the alkaline agent is large, the molecules cannot smoothly move, and therefore the chemical reaction by the alkaline agent slowly progresses.

The third step in the manufacturing method 10A for the low-calorie sol food material according to Example 1 is a step that the pH-adjusted sol substance 7 prepared in the above step S02 is heated to a temperature range of 70 to 130° C. to produce a gelatinous substance 8 (step S03). That is, a step that coagulation of the glucomannan in the pH-adjusted sol substance 7 is progressed.

Performing of heating treatment in this step S03 causes a chemical reaction for desorbing acetyl groups from the glucomannan molecules in the pH-adjusted sol substance 7, and the glucomannan molecules mutually form a three-dimensional network through hydrogen bonds, resulting in progression of the coagulation thereof.

In this step S03, heating should be stopped before syneresis from the gelatinous substance 8 to the extent visibly confirmable is caused, and this will be explained in detail below.

The reason for this is that the gelatinous substance 8 from which visibly-confirmable syneresis is not caused can be rendered a thermoreversible sol substance by the subsequent fourth step (cooling treatment), whereas, when visibly-confirmable syneresis from the gelatinous substance 8 is caused, the gelatinous substance 8 cannot be rendered a thermoreversible sol substance even by performing the subsequent fourth step.

Note that whether or not the gelatinous substance 8 is produced in the step S03 can be easily judged by evaluating whether or not a heat-treated object has elasticity. In addition, whether or not the gelatinous substance 8 is irreversibly gelled can be easily judged by visually confirming whether or not a transparent liquid is separated from the gelatinous substance 8.

In addition, since the chemical reaction for coagulating the glucomannan as mentioned above progresses only by leaving the pH-adjusted sol substance 7 at normal temperature, the step S03 is not considered to be necessarily required.

However, unless coagulation of the glucomannan in the low-calorie sol food material 1a is in a state progressed to some extent, there was a need for long-time cooking for gelling a processed food when the low-calorie sol food material 1a is kneaded into other food materials to produce the processed food, and therefore this was not practical.

Accordingly, in order to reliably gel the processed food prepared by kneading the low-calorie sol food material 1a according to the present invention into other food materials by short-time cooking, coagulation of the glucomannan should be progressed to some extent by performing this step S03.

In the third step, the poorly-soluble water absorbent 4 in the pH-adjusted sol substance 7 has an effect to slowly progress coagulation of the glucomannan.

This can prevent the gelatinous substance 8 from irreversibly gelling unintentionally and becoming a defective product during the third step. Thus, the low-calorie sol food material 1a according to Example 1 can be stably produced and supplied.

In addition, since water retentivity of the gelatinous substance 8 is enhanced by the poorly-soluble water absorbent 4, the timing for visibly-confirmable syneresis from the gelatinous substance 8 is delayed. This can prevent the gelatinous substance 8 from becoming a defective product during the third step.

In addition, the fourth step in the manufacturing method 10A for the low-calorie sol food material according to Example 1 is a step that the gelatinous substance 8 produced in the above step S03 is cooled to a temperature range of 0 to 15° C. and rendered a thermoreversible sol substance (step S04). That is, the step 4 is a step that a coagulation rate of the glucomannan constituting the gelatinous substance 8 is exponentially delayed by discontinuing the heating of the gelatinous substance 8 and cooling it to render the gelatinous substance 8 a gelatinous coagulated body in a transition state before coagulation of the glucomannan has thoroughly progressed.

In the low-calorie sol food material 1a manufactured by the manufacturing method 10A for the low-calorie sol food material according to Example 1 as mentioned above, the poorly-soluble water absorbent 4 is dispersed therein, and thereby coagulation of the glucomannan progresses slower than in a case without inclusion of the poorly-soluble water absorbent 4. That is, the time it takes the low-calorie sol food material 1a to irreversibly gel is longer than in the case without inclusion of the poorly-soluble water absorbent 4. Consequently, thermal reversibility of the low-calorie sol food material 1a can be sustained for a long period of time. Consequently, the quality stability of the low-calorie sol food material 1a can be enhanced, and therefore its storability can be improved.

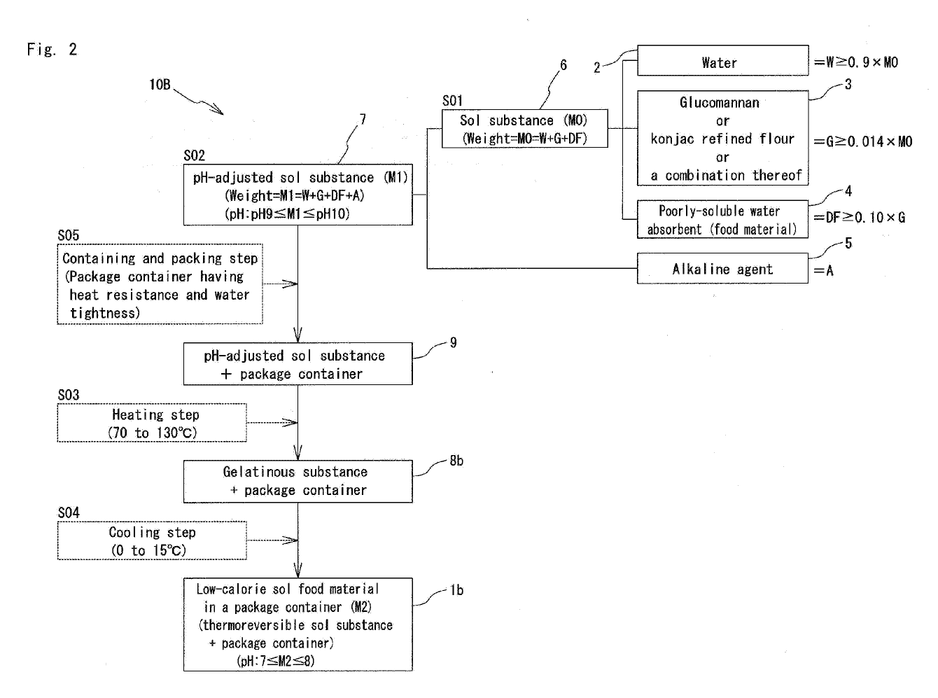

Next, the manufacturing method for the low-calorie sol food material according to Example 2 in the present invention will be explained with reference to FIG. 2.

FIG. 2 is a flowchart of the manufacturing method for the low-calorie sol food material according to Example 2 in the present invention. Note that, for the same part as described in the foregoing FIG. 1, the same reference symbol is given, and explanation about its constitution is omitted.

As shown in FIG. 2, in the manufacturing method 10B for the low-calorie sol food material according to Example 2, a containing and packing step (step S05) that a desired amount of pH-adjusted sol substance 7 is contained and sealed in a package container with heat resistance and water tightness is included between the second step (step S02) and the third step (step S03) in the manufacturing method 10 for the low-calorie sol food material according to the above-mentioned Example.

In addition, by including the containing and packing step (step S05), the heat-treated object in the step S03 becomes a pH-adjusted sol substance in a package container 9.

According to the manufacturing method 10B for the low-calorie sol food material according to the foregoing Example 2, the heating treatment for progressing coagulation of the glucomannan in the pH-adjusted sol substance 7 and the heating treatment for sterilizing and sanitating the pH-adjusted sol substance 7 can be simultaneously completed.

In addition, contents in a low-calorie sol food material in a package container 1b manufactured by the manufacturing method 10B for the low-calorie sol food material according to the Example 2 is the low-calorie sol food material 1a according to Example 1.

As mentioned above, the low-calorie sol food material 1a according to the present invention is a sol coagulated body in a transition state before the glucomannan is thoroughly coagulated, and this coagulated body eventually becomes an irreversible gelatinous substance as the coagulation of the glucomannan further progresses by the action of heat.

Additionally, in the case of the manufacturing method 10A for the low-calorie sol food material according to the foregoing Example 1, the step S05 as in Example 2 is not included, and therefore a heating treatment intended for sterilization may be required separately, when the produced low-calorie sol food material 1a is packaged for shipping.

However, the separate heating treatment of the low-calorie sol food material 1a needs to be progression of coagulation of the glucomannan, and it considerably decreases durability of the quality of low-calorie sol food material 1a.

In contrast, in the case of the manufacturing method 10B for the low-calorie sol food material according to the Example 2, inclusion of the step S05 prevents the heat-treated low-calorie sol food material 1a from being contaminated with saprophytic bacteria, etc., while the coagulation of the glucomannan can be progressed to a desired degree. That is, when a processed food is manufactured using the low-calorie sol food material 1a manufactured by the manufacturing method 10B for the low-calorie sol food material according to the Example 2, coagulation of the glucomannan in the low-calorie sol food material 1a can be progressed to a degree where this processed food can be gelled only by simple cooking.

Consequently, according to the manufacturing method 10B for the low-calorie sol food material according to the Example 2, the low-calorie sol food material 1a in which the coagulation of the glucomannan more-slowly progresses to a degree where the coagulation does not affect its use as a processed food, can be manufactured and provided. That is, the quality keeping period of the low-calorie sol food material 1a contained in the low-calorie sol food material in the package container 1b according to Example 2 can be prolonged.

Also, as in the manufacturing method 10B for the low-calorie sol food material according to Example 2, there has been a concern that when the pH-adjusted sol substance 7 is packed in a package container and then heat-treated, irreversible gelation is easily caused on outer margins and their peripheries as well as corner portions and their peripheries of the package container.

The reason for this is that the pH-adjusted sol substance 7 is relatively thin on the outer margins and their peripheries as well as the corner portions and their peripheries of the package container, these sites are excessively heated in heating treatment, and coagulation of the glucomannan is likely to rapidly progress.

However, in the case of the manufacturing method 10B for the low-calorie sol food material according to the Example 2, even when the gelatinous substance 8 is partially excessively-heated by dispersing the poorly-soluble water absorbent 4 in the pH-adjusted sol substance 7 packed in the package container, irreversible gelation of the site can be suppressed.

Consequently, according to the manufacturing method 10B for the low-calorie sol food material according to Example 2, the low-calorie sol food material 1a in the package container can be brought into a homogenous state. Consequently, the low-calorie sol food material 1a with homogenous quality can be efficiently and hygienically produced.

This low-calorie sol food material in the package container 1b is suitable for transport and storage.

The pH of the low-calorie sol food material 1a manufactured by the manufacturing methods 10A and 10B for the low-calorie sol food materials according to Examples 1 and 2 is approximately neutral ranging pH 7 to 8. Thus, when the low-calorie sol food material 1a according to this Example is kneaded into other food materials, the tastes and colors of other food materials are very unlikely to be deteriorated. Consequently, the low-calorie sol food material 1a which has an excellent property as a food material for processing can be provided.

In addition, since this low-calorie sol food material 1a according to the present invention becomes a gelatinous solid by heating, a food with a thermocoagulation property can be bulked without a sense of incongruity. In addition, the low-calorie sol food material 1a itself according to the present invention has a property to incorporate and seal water and oil content (drip). Thereby, water and oil content from other food materials can be sealed in the processed food by kneading the low-calorie sol food material 1a according to the present invention therein to manufacture a juicy processed food having moderate elasticity.

More specifically, when a hamburger comprising only ground meat of livestock without the low-calorie sol food material 1a according to the present invention and a hamburger prepared by kneading the low-calorie sol food material 1a according to the present invention into ground meat of livestock in which a contents percentage of the low-calorie sol food material 1a was 40 w % were made, and weights of each hamburger before and after cooking were measured, the former showed the decreased weight by 25% through evaporation and leakage of water and oil content, whereas the latter showed the decreased weight by 17%. Note that the low-calorie sol food material 1a according to the present invention kneaded into this hamburger is equal to the invention 3 prepared for the test described below.

Consequently, the low-calorie sol food material 1a according to the present invention is suitable particularly for a food material kneaded into a ground meat product.

In addition, since most of the low-calorie sol food material 1a according to the present invention is water, the calories of the processed food can be reduced by replacing a part of the processed food with the low-calorie sol food material 1a according to the present invention. Consequently, a food material useful for prevention and treatment of lifestyle diseases resulting from dietary habits can be provided. Particularly, when the food material is kneaded into the ground meat product to produce a processed food, it is possible to considerably reduce not only the intake of calories but also the intake of lipids and proteins, and thus it is most suitable as the processed food for prevention and treatment of diabetes, obesity or the like.

In addition, since the glucomannan contained in the low-calorie sol food material 1a is a dietary fiber, the intake of the dietary fiber can be increased by taking the low-calorie sol food material 1a. As a result, the health promoting effects resulting from intake of the dietary fiber can also be expected.

More specifically, the increased intake of the plant fiber facilitates bowel movement through promoted intestinal peristalsis. In addition, since the glucomannan which is a water-soluble dietary fiber makes viscous solution by incorporating water, it acts so as to slow down passage of foods from the stomach to the small intestine and a rise in blood sugar level, and to suppress a rise in the blood sugar level. Thereby, it is possible to effortlessly make insulin to act, the burden on insulin production can be eliminated, and thus the glucomannan is effective for prevention and treatment of diabetes. Furthermore, because of the increased intake of plant fibers, an effect to block absorption of cholesterol and an effect to reduce development of colon cancer can be exerted.

Here, a mechanism that the irreversible gelation of the glucomannan is delayed by dispersing the poorly-soluble water absorbent 4 in the pH-adjusted sol substance 7 will be explained.

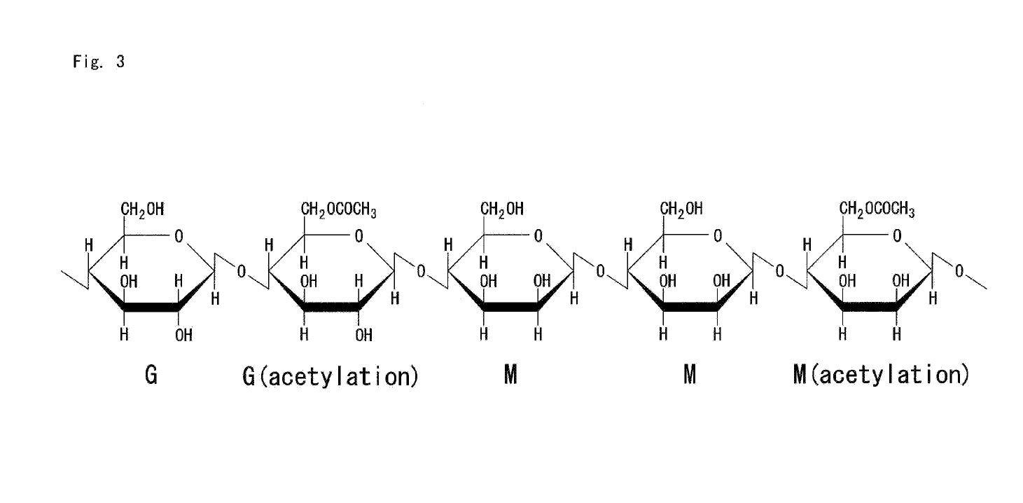

Although the mechanism of the irreversible gelation of the glucomannan has not been elucidated in detail, it is currently considered that the irreversible gelation is caused in a process as shown below. FIG. 3 is a structural formula of the glucomannan.

As shown in FIG. 3, the glucomannan is a polymer constituted by a large number of bonds of glucose (G) and mannose (M) in a ratio of approximately 2:3. In addition, the konjac glucomannan as an active ingredient of the konjac is present in a state that some parts of its hydroxyl groups on glucose (G) and mannose (M) are esterized. For example, as shown in the structural formula of FIG. 3, a part of the hydroxyl group (—OH) on the glucomannan molecule is substituted by an acetyl group (—COCH₂).

When such a glucomannan receives thermal action, the acetyl group is hydrolyzed to produce a lower acid (acetic acid), and in the glucomannan molecule, the site where the acetyl group was present is substituted by the hydroxyl group (—OH group). In addition, since usually this reaction reversibly occurs, the state is in chemical equilibrium, where the acetyl groups are not apparently decreased.

However, in a case that the glucomannan molecule is under an alkaline environment, it is considered that the lower acid (acetic acid) produced by the foregoing hydrolysis is neutralized by an alkaline agent, the foregoing hydrolysis irreversibly progresses, and the acetyl group on the glucomannan molecule gradually decreases.

In addition, the glucomannan molecule from which the acetyl group is desorbed is considered to forma three-dimensional network while forming a micellar joint area by intermolecular hydrogen bonds to gel the glucomannan.

In addition, the process for the gelation of the glucomannan caused by spread of the micellar joint area as mentioned above is considered to vary depending on the alkalinity of the solution containing the glucomannan molecules.

In a case that the glucomannan molecule is under a strong alkaline environment, i.e. in a case that the conventionally-known gelatinous konjac is manufactured, the lower acid (acetic acid) comprising the acetyl group desorbed from the glucomannan molecule is rapidly neutralized by the alkaline agent, thereby desorption of the acetyl group from the glucomannan molecule rapidly progresses, and accordingly, the three-dimensional network comprising the glucomannan molecules is also rapidly formed. Thus, it is considered that water is rapidly extruded from between the glucomannan molecules (syneresis is caused), resulting in irreversible gelation.

In contrast, in a case that the glucomannan molecule is under a weak alkaline environment, it is considered that desorption of the acetyl group as mentioned above and accompanying formation of the three-mentioned network by the glucomannan molecule slowly progress. In addition, the sol coagulated body in a transition state where the coagulation of the glucomannan slowly progresses as mentioned above is considered to be the thermoreversible sol substance of the present invention (low-calorie sol food material 1a).

The desorption of the acetyl group from the glucomannan molecule and neutralization reaction of the lower acid (acetic acid) comprising the desorbed acetyl group by the alkaline agent as mentioned above are considered to smoothly progress by heating. Consequently, this may be the reason why the gelatinous substance is produced when the heating process is performed in the manufacturing methods 10A and 10B for the low-calorie sol food material according to this Example.

That means, the reason why the thermal reversibility can be sustained by storing and distributing the thermoreversible sol substance of the present invention (low-calorie sol food material 1a) so that exposure to heat is minimized after manufacture may be because formation of the three-dimensional network comprising the glucomannan molecules from which the acetyl group was desorbed slowly progresses.

On the other hand, desorption of the acetyl group from the glucomannan molecule and neutralization reaction of the lower acid (acetic acid) comprising the desorbed acetyl group by the alkaline agent under a weak alkaline environment are considered to preferably progress by adding thermal energy as mentioned above. That is, it is considered that once the coagulation of the glucomannan starts under a weak alkaline environment, the chemical reaction shifts only to a direction allowing the coagulation of the glucomannan to progress.

This may be the reason that the thermal reversibility of the thermoreversible gelatinous substance (low-calorie sol food material 1a) of the present invention cannot remain fixed.

In addition, in a state that desorption of the acetyl group from the glucomannan molecule progresses, the three-dimensional network comprising the glucomannan molecules is formed throughout the solution, and visibly-confirmable syneresis occurs by extrusion of the water molecule from this three-dimensional network, is considered to be a state of irreversible gelation (conventionally-known konjac).

This point coincides with the point that even if the gelatinous substance 8 in which syneresis is caused to the extent visibly confirmable is cooled during heating treatment in the step S03, the thermoreversible sol substance cannot be produced in the manufacturing methods 10A and 10B for the low-calorie sol food material according to Examples 1 and 2.

Considering the above-mentioned coagulation process of the glucomannan, it is considered to be possible to slow down a coagulation rate of the glucomannan by preventing neutralization of the lower acid (acetic acid) constituted through desorption from the glucomannan molecule by an alkaline agent. In other words, it is considered that the duration of thermal reversibility of the thermoreversible sol substance in a transition state can be prolonged.

In consideration of this circumstance, in the present invention, an alkaline aqueous solution or alkaline agent dispersion liquid (alkaline agent 5) is absorbed preferentially in the poorly-soluble water absorbent 4 by dispersing the poorly-soluble water absorbent 4 with lower water absorbency than that of the glucomannan in the sol substance 6, when the pH-adjusted sol substance 7 is prepared by adding the alkaline agent to the sol substance 6 (second step).

In this case, it is considered that the alkaline agent 5 is gradually supplied from the poorly-soluble water absorbent 4 during the heating step in the step S03, and the neutralization reaction of the lower acid (acetic acid) comprising the acetyl group desorbed from the glucomannan molecule slowly progresses. As a result, it is considered that the irreversible desorption of the acetyl group from the glucomannan molecule also slowly progresses.

Consequently, it is considered that the coagulation of the glucomannan also slowly progresses.

In addition, the poorly-soluble water absorbent 4 dispersed in the low-calorie sol food material 1a has an effect to absorb water extruded from between the glucomannan molecules when the glucomannan from which the acetyl group is desorbed forms the three-dimensional network.

Thus, water retentivity of the gelatinous substance 8 produced during the heating treatment as the third step is enhanced by dispersing the poorly-soluble water absorbent 4 in the pH-adjusted sol substance 7, and occurrence of the apparent syneresis from the gelatinous substance 8 can be delayed.

Thereby, during the heating treatment in the third step, the timing for starting the fourth step can be delayed to prevent the low-calorie sol food material 1a from irreversibly gelating and becoming a defective product.

Thus, the poorly-soluble water absorbent 4 dispersed in the pH-adjusted sol substance 7 functions as a buffer which can broaden a range of timing for discontinuing the heating treatment.

Here, the poorly-soluble water absorbent 4 used in Examples 1 and 2 in the present invention will be explained.

In order to exert the long-lasting effects for the thermal reversibility of the low-calorie sol food material 1a according to the present invention by the poorly-soluble water absorbent 4, the poorly-soluble water absorbent 4 of at least 10 wt % or more of the total weight of the glucomannan-containing material powder 3 to be used should be contained.

On the other hand, the more the additive amount of the poorly-soluble water absorbent 4 increases, the stickier the low-calorie sol food material 1a according to the present invention becomes, and its handling becomes difficult. Consequently, the additive amount of the poorly-soluble water absorbent 4 should be preferably within the range of 10 to 100 wt % of the total weight of the glucomannan-containing material powder 3 to be used.

As the poorly-soluble water absorbent 4 exerting the above-mentioned effects, a polymer having a lower water absorbency than that of the glucomannan is preferably used. More specifically, a water-absorbable natural polymer containing 80 wt % or more of a substance insoluble to water is preferably used. As such a water-absorbable natural polymer containing 80 wt % or more of a substance insoluble to water, e.g. dietary fibers derived from animal resources or plant resources can be used.

Particularly, when a dietary fiber is used as the poorly-soluble water absorbent 4, both the glucomannan-containing material powder 3 which is a solid matter other than the alkaline agent 5 constituting the low-calorie sol food material 1a according to the present invention and the poorly-soluble water absorbent 4 are composed of an indigestible component which is not digested by a human digestive enzyme. Consequently, the calories of the low-calorie sol food material 1a according to the present invention can be considerably reduced.

Furthermore, a novel low-calorie processed food can be manufactured and provided by kneading this low-calorie sol food material 1a according to the present invention with other food materials. As a result, food materials and foods which can contribute to prevention and treatment of lifestyle diseases resulting from dietary habits can be provided. Furthermore, effects to increase an intake of dietary fibers by taking the low-calorie sol food material 1a according to the present invention can also be expected. Thereby, health promoting effects associated with an increase in the intake of dietary fibers can also be expected.

Also, it is often the case that, among the dietary fibers, the dietary fibers derived from animal resources have distinctive odors. Thus, when it is intended to bring the low-calorie sol food material 1a according to Examples 1 and 2 into odorlessness as much as possible, the dietary fibers derived from the animal resources should not be used. On the other hand, when the low-calorie sol food material 1a according to the present invention is made into a processed food e.g. by kneading it into a mince of a marine product or the like, an excellent flavor can be potentially provided by a dietary fiber derived from an animal resource. Consequently, it is necessary to select an appropriate dietary fiber as the poorly-soluble water absorbent 4 according to the intended use.

Among the dietary fibers, particularly the dietary fibers derived from the plant resources are particularly suitable for a case that the low-calorie sol food material 1a according to the present invention is intended to be rendered tasteless and odorless.

Such dietary fibers derived from plant resources may include e.g. wheat-derived dietary fibers, oat-derived dietary fibers, etc.

In addition, some plant dietary fibers have distinctive colors. In this case, a plant dietary fiber having an appropriate color should be selected according to the intended use, because when the low-calorie sol food material 1a according to the present invention is kneaded into other food materials for use, colors of the other food materials may be deteriorated.

Furthermore, particularly when a dietary fiber derived from a plant resource is used, the moisture retaining effect of the low-calorie sol food material 1a according to the present invention varies according to the length of the dietary fiber.

When the mean fiber length of the dietary fiber is over 80 μm, the moisture retaining effect of the gelatinous substance 8 is enhanced, while a slight stickiness easily occurs to the low-calorie sol food material 1a.

On the other hand, when the mean fiber length is 80 μm or shorter, the moisture retaining effect of the gelatinous substance 8 is somewhat low, but stickiness hardly occurs to the low-calorie sol food material 1a. Thus, when the low-calorie sol food material 1a using the dietary fiber with 80 μm or shorter of mean fiber length is used as a food material for the processed food, moldability of the kneaded food can be improved. Consequently, the low-calorie sol food material 1a using the dietary fiber with 80 μm or shorter of mean fiber length as the poorly-soluble water absorbent 4 is particularly suitable as a food material which is kneaded into a ground meat product.

Finally, tests for studying differences of effects in cases that three dietary fibers having different fiber lengths were used as the poorly-soluble water absorbent 4, and their results will be explained.

The sol substance 6 for the low-calorie sol food material 1a according to the present invention was prepared in compounding ratios described in Table 1 below, the alkaline agent was added to each of them to produce the pH-adjusted sol substances 7 in a range of pH 9.7 to 9.9, and then the pH-adjusted sol substance 7 was packed in a transparent package container having water tightness and heat resistance. These were heated by steam under a temperature condition ranging 98 to 100° C., and states of coagulation and syneresis were observed. Note that, in these tests, a dietary fiber derived from a plant resource and having 90 wt % or more of a substance insoluble to water was subjected to the tests.

In addition, in these tests, the presence or absence of syneresis from the gelatinous substance 8 in the heating treatment was judged by evaluating whether or not the presence of a transparent liquid can be visually confirmed in a corner of the package container of which the inside can be seen through.

TABLE 1

| | | Additive amount of | |
|---|---|---|---|
| | Contentspercentage | dietary fibers | Length of |
| | of glucomannan | (with respect to the | dietary fiber |
| | (in 100 pts. wt. of | total amount of | (Mean fiber |
| | sol substance) | glucomannan) | length) |
| Invention 1 | 2.5 wt % | 40 wt % | 250 μm |
| Invention 2 | 2.5 wt % | 40 wt % | 80 μm |
| Invention-3 | 2.5 wt % | 40 wt % | 30 μm |
| Control | 2.5 wt % | No addition | — |

The control containing no dietary fiber became the gelatinous substance 8 when 45 minutes elapsed since the start of heating, and syneresis from the gelatinous substance 8 was confirmed from the time 55 minutes elapsed since the start of heating. In the control, the time until the start of syneresis after it became the gelatinous substance 8 was only 10 minutes.

In contrast, all of the inventions 1 to 3 into which the dietary fibers were kneaded became the gelatinous substance 8 when 60 minutes elapsed since the start of heating.

Furthermore, in the invention 1 into which a dietary fiber having the longest mean fiber length was kneaded, syneresis began from the time 90 minutes elapsed since the start of heating. The time until the start of syneresis after the invention 1 became the gelatinous substance 8 was 30 minutes.

In both the inventions 2 and 3 into which dietary fibers having the middle mean fiber length and the shortest mean fiber length were kneaded respectively, the syneresis began from the time 80 minutes elapsed since the start of heating. The time until the start of syneresis after the inventions 2 and 3 became the gelatinous substances 8 was 20 minutes.

In addition, even after the inventions 1 to 3 were stored under a temperature condition of 5 to 10° C. for 2 months, no irreversible gelation occurred.

Consequently, the above test results showed that during the heating treatment in manufacturing the low-calorie sol food material 1a according to the present invention, the time until the start of syneresis after it became the gelatinous substance 8 could be prolonged by 2 to 3 times, by containing a dietary fiber having 90 wt % or more of a substance insoluble to water as the poorly-soluble water absorbent 4.

Consequently, in the low-calorie sol food material 1a according to the present invention, the water retentivity of the gelatinous substance 8 can be enhanced by containing a dietary fiber having 90 wt % or more of a substance insoluble to water as an aggregation inhibitor 4.

Also, the above test showed that the longer the length of the length of the dietary fiber which is added to the low-calorie sol food material 1a according to the present invention and has 90 wt % or more of a substance insoluble to water, the higher the moisture retaining effect.

In addition, through the above test, it was also confirmed that coagulation of the glucomannan was delayed by dispersing a dietary fiber having 90 wt % or more of a substance insoluble to water as the poorly-soluble water absorbent 4 in the low-calorie sol food material 1a.

Furthermore, when samples were collected from different 5 sites in the gelatinous substances 8 which showed no syneresis in the above test (inventions 1 to 3) and they were measured for pH, all of them were within a range of pH 7 to 8.

The pH-adjusted sol substance 7 which was weak alkaline at pH 9.7 to 9.9 before heating was within a range of pH 7 to 8 in a state of a thermoreversible gelatinous substance prepared by heating for gelation and then cooling. This is considered to be attributed to the fact that the alkaline agent was neutralized by a lower acid produced from the acetyl group desorbed from the glucomannan molecule by heating the glucomannan under the alkaline environment.

Thus, a decrease in alkalinity due to the low-calorie sol food material 1a according to the present invention after manufacture approaching neutral pH is also considered to be one of the factors that lower the coagulation rate of the glucomannan in the low-calorie sol food material 1a according to the present invention. Consequently, it is considered that irreversible gelation of the glucomannan is delayed also by this action.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### INDUSTRIAL APPLICABILITY

As described above, the present invention relates to the low-calorie sol food material and the low-calorie sol food material in a package container in which the thermal reversibility can be sustained for a long period of time, and the manufacturing method thereof, and is also usable in fields related to food processing, medical care, pet foods and the like.

1. A manufacturing method of a low-calorie sol food material, the method comprising the steps of:
stirring a mixture of water, glucomannan or konjac refined flour or a combination thereof, and a poorly-soluble water absorbent, whereby the mixture is swollen to form a sol substance;
kneading an alkaline agent into the sol substance to prepare a pH-adjusted sol substance;
heating the pH-adjusted sol substance under a temperature condition at 70 to 130° C. to make the pH-adjusted sol substance into a gelatinous substance, and
cooling the gelatinous substance to a temperature range of 0 to 15° C. to make the gelatinous substance solate.

2. The manufacturing method of the low-calorie sol food material according to claim 1, the method comprising:
between the step of the kneading and the step of heating, sealing the pH-adjusted sol substance in a package container with heat resistance and water tightness.

3. A low-calorie sol food material in a range of pH 7 to 8 which is constituted by heating a pH-adjusted sol substance obtained by kneading an alkaline agent into a sol substance prepared by stirring and swelling water, glucomannan or konjac refined flour or a combination thereof, and a poorly-soluble water absorbent to gelate, then cooling to solate, wherein:
a percentage of moisture content in the sol substance is 90 wt % or more;
a contents percentage of the glucomannan or the konjac refined flour or the combination thereof in the sol substance is 1.4 wt % or more; and
an amount of the added poorly-soluble water absorbent is 10 wt % or more of the total weight of the glucomannan or the konjac refined flour or the combination thereof.

4. The low-calorie sol food material according to claim 3, wherein the poorly-soluble water absorbent is a natural polymer having 80 wt % or more of a substance insoluble to water.

5. The low-calorie sol food material according to claim 4, wherein the poorly-soluble water absorbent is a dietary fiber derived from a plant resource.

6. The low-calorie sol food material according to claim 5, wherein a mean fiber length of the dietary fiber is within a range of 30 to 80 μm.

7. A low-calorie sol food material with a package container, comprising:
the low-calorie sol food material according to claim 3; and
a package container having heat resistance and water tightness,
wherein the low-calorie sol food material is sealed in the package container.

8. A low-calorie sol food material with a package container, comprising:
the low-calorie sol food material according to claim 4; and
a package container having heat resistance and water tightness, wherein the low-calorie sol food material is sealed in the package container.

9. A low-calorie sol food material with a package container, comprising:
the low-calorie sol food material according to claim 5; and
a package container having heat resistance and water tightness, wherein the low-calorie sol food material is sealed in the package container.

10. A low-calorie sol food material with a package container, comprising:
the low-calorie sol food material according to claim 6; and
a package container having heat resistance and water tightness, wherein the low-calorie sol food material is sealed in the package container.
